(19) United States
(12) Patent Application Publication
(10) Pub. No.: US 2025/0168574 A1
(43) Pub. Date: May 22, 2025

(54) HEARING DEVICE WITH HARD-MOUNTED RECEIVER

(71) Applicant: GN Hearing A/S, Ballerup (DK)

(72) Inventor: Yu LUAN, Kongens Lyngby (DK)

(73) Assignee: GN Hearing A/S, Ballerup (DK)

(21) Appl. No.: 18/911,193

(22) Filed: Oct. 9, 2024

(30) Foreign Application Priority Data
Nov. 16, 2023 (EP) 23210246.7

(51) Int. Cl. H04R 25/00

(52) U.S. Cl. CPC H04R 25/48; H04R 25/604; H04R 25/65

(57) ABSTRACT

The present disclosure relates to a hearing device that comprises a receiver support structure and a loudspeaker, such as a hearing device receiver. The loudspeaker comprises a vibratory motor assembly housed inside a receiver casing. The receiver casing is rigidly fixed to the receiver support structure so as to eliminate the need for a receiver suspension.

### RELATED APPLICATION DATA

This application claims priority to, and the benefit of European Patent Application No. 23210246.7 filed on Nov. 16, 2023. The entire disclosure of the above application is expressly incorporated by reference herein.

### FIELD

The present disclosure relates to a hearing device that comprises a receiver support structure and a loudspeaker, such as a hearing device receiver. The loudspeaker comprises a vibratory motor assembly housed inside a loudspeaker casing such as a receiver casing. The receiver casing is fixed to the receiver support structure.

### BACKGROUND

It is generally desirable to achieve a high gain in hearing devices such as hearing aids and hearing instruments to compensate for even large hearing losses of the users. The gain may be determined in numerous ways, for example in a standardized measurement set-up where the sound field at a microphone of the hearing device and output sound pressure delivered by a receiver or loudspeaker are determined in a standardized manner. The output sound pressure may for example be measured by a specified ear simulator or acoustic coupler that may represent average acoustic characteristics of human ears.

However, intrinsic mechanical feedback paths and acoustic feedback paths limit the maximum gain that can be achieved in most hearing devices. The mechanical feedback path is created by transmission of mechanical vibrations of the receiver casing, caused by vibrations of the receiver motor assembly, through various housing structures of the hearing device and back to the microphone. The acoustic feedback path is created by acoustic transmission of sound pressure back to the microphone through various acoustic leakage paths of the housing and its sound tubes.

Instability of the hearing device caused by these feedback paths is sometimes audible as a continuous, typically high-frequency, tone or whistle emanating from the device. The stability limit of the hearing device can conveniently be expressed by the so-called maximum stable gain which represents the stability limit of the hearing device in a specific measurement set-up.

It has been common practice in prior art hearing devices to suspend the receiver in a soft resilient suspension surrounding a receiver casing to suppress or attenuate vibration transfer through the mechanical feedback path. Prior art resilient suspensions have for example been made of an elastomeric material like rubber or neoprene.

However, the soft resilient suspension occupies space around the receiver and thereby leads to increased dimensions of a housing of the hearing device. This is disadvantageous because there exists a general desire to minimize the dimensions of the hearing device housing for example to reduce its visibility and increase user comfort.

### SUMMARY

Thus, the above-described problems are solved according to a first aspect of the present disclosure by providing a hearing device comprising:
a housing comprising an outer wall configured for arrangement at, or, in a user's ear and an inner wall defining an interior housing volume comprising a receiver support structure,
a receiver comprising:
a receiver casing comprising a vibratory motor assembly housed inside the receiver casing, wherein the receiver casing is fixed to the receiver support structure.

According to one embodiment, the receiver casing is fixed to the receiver support structure by press-fitting at least one section of the receiver casing into a mating recess of the receiver support structure. This press-fitting preferably creates physical contact between the receiver casing and the receiver support structure such that these may be rigidly connected. The press-fitting between the at least one section of the receiver casing and the receiver support structure may be accomplished by making one or more dimensions of the recess smaller than the mating dimension(s) of the at least one section of the receiver casing. The at least one section of the receiver casing may comprise a pair of substantially plane opposing, for example substantially parallel, casing walls.

The receiver casing may comprise a substantially box-shaped base section, which comprises the substantially parallel, casing walls, and a cylindrical sound port mounted on a sound outlet of the box-shaped base. The receiver casing may in other embodiments have a generally cylindrical shape and the recess of the receiver support structure possessing a mating cylindrical recess with smaller dimensions, e.g. smaller diameter, that the dimensions of the generally cylindrical receiver casing.

The receiver casing may for example be rigidly fixed to the receiver support structure without a traditional resilient or compliant suspension structure like elastomeric suspensions arranged between the receiver casing and the receiver support structure.

According to embodiments of the hearing device, the least one section of the receiver casing is fixed or attached to the receiver support structure by an adhesive agent such as a non-compliant and healed glue or hardened glue. The glue may for example comprise a rapid-curing cyanoacrylate glue or an epoxy resin glue or any other glue as discussed in additional detail below with reference to the appended drawings. The healed glue or hardened glue preferably makes a rigid connection between the at least one section of the receiver casing and the receiver support structure.

In some embodiments of the hearing device the receiver support structure comprises a receiver compartment surrounding the receiver. The one or more walls of the receiver casing is/are rigidly fixed to one or more mating inner walls of the receiver compartment. The receiver compartment is preferably closed and acoustically seals the receiver against the interior housing volume of the hearing device. This acoustic sealing attenuates sound leakage from the receiver casing and sound outlet into the interior housing volume of the hearing device.

The skilled person will appreciate that a rigid connection between the at least one section of the receiver casing and the receiver support structure can be understood as a hard-mount of the receiver to the receiver support structure.

Surprisingly, the hard-mount of the receiver leads to a favorable reduction of the level of feedback through the mechanical feedback path to the microphone(s). Hence improving stability of the hearing device, for the reasons discussed in additional detail below with reference to the appended drawings.

The vibratory motor assembly of the receiver may at least comprise one of:
a moving armature drive configured to vibrate a diaphragm to generate and emit sound output,
an electrodynamic drive, e.g., a moving coil drive, configured to vibrate a diaphragm to generate and emit sound output,
a piezo-electric drive configured to vibrate a diaphragm to generate and emit sound output. Hence, various types of loudspeakers may be utilized and an exemplary balanced moving armature type of receiver as discussed in additional detail below with reference to the appended drawings.

The material of the receiver support structure may possess a Young's modulus between 60 MPa and 200 MPa, such as between 120 MPa and 140 MPa as discussed in additional detail below with reference to the appended drawings.

The housing of the hearing device may have well-known shapes adapted to a particular arrangement on the user's ear such as at least one of a BTE hearing device, an ITC hearing device, an ITE hearing device and a RIC hearing device. The hearing device may comprise a microphone arrangement positioned in the interior housing volume and configured for pick-up of sound from a surrounding environment of the hearing device.

One embodiment of the hearing device comprises a housing that is manufactured by low-pressure molding around the receiver and thereby simply assembly of the hearing device. The low-pressure molding may fully encapsulate the receiver.

The hearing device according to any of the preceding claims, wherein a dominant, resonance frequency of the receiver and housing assembly is above 10 kHz. The dominant resonance frequency of the receiver and housing assembly may be determined by a maximum stable gain measurement as discussed in additional detail below with reference to the appended drawings.

### BRIEF DESCRIPTION OF THE FIGURES

Hearing devices will now be described in additional detail with reference to the accompanying figures.

FIG. 1 schematically illustrates an exemplary BTE hearing device mounted at a user's ear,

FIG. 2 is a first cross-sectional perspective view of a prior art hearing device using a resilient receiver suspension,

FIG. 3 is a second cross-sectional perspective view of the prior art BTE hearing device comprising a receiver chamber mounted inside a housing of the BTE hearing device,

FIG. 4 is a cross-sectional perspective view of the receiver chamber as mounted inside a housing of the prior art BTE hearing device,

FIG. 5 is a cross-sectional perspective view of an exemplary BTE hearing device according to some embodiments,

FIG. 6 is a longitudinal cross-sectional view of an exemplary balanced-armature receiver,

FIG. 7 is a schematic illustration of a press-fitted mounting of the exemplary balanced-armature receiver in a receiver support structure of the housing of the exemplary BTE hearing device in accordance with a first embodiment,

FIG. 8 is a schematic illustration of a mounting of the exemplary balanced-armature receiver in a receiver support structure of the housing of the exemplary BTE hearing device using a rigid adhesive agent in accordance with a second embodiment,

FIG. 8A is a schematic circuit diagram of variables of a measurement set-up for measuring maximum stable gains of hearing aids such as the first and second embodiments of the BTE hearing device; and

FIG. 9 shows experimentally measured maximum stable gains of a prior art BTE hearing device in comparison to a BTE hearing device in accordance with the present disclosure.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

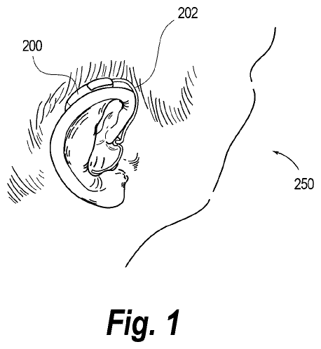

FIG. 1 illustrates an exemplary BTE hearing device 200 according to some embodiments mounted at an ear of a user 250. The housing of the BTE hearing device is shaped and sized for mounting behind the user's ear lobe. A sound tube 202 conveys output sound pressure of the BTE hearing device 200 to the user's ear canal. The output sound pressure is typically a processed version of an input sound pressure at a microphone arrangement (not shown) of the BTE hearing device 200. The microphone arrangement may be positioned in interior housing volume and configured for pick-up of sound such as speech and noise from the surrounding environment of the hearing device 200. The BTE hearing device 200 typically comprises a software programmable processing unit (not shown) such as a microprocessor and/or DSP (not shown) that is configured to process signals by applying various signal processing algorithms to the sound picked-up or received by the microphone arrangement. The signal processing algorithms may comprise one or more of: hearing loss compensation, beamforming, noise-reduction, dynamic range compression, power amplification etc.

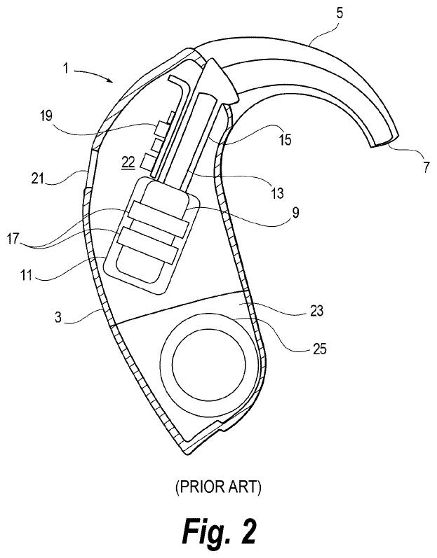

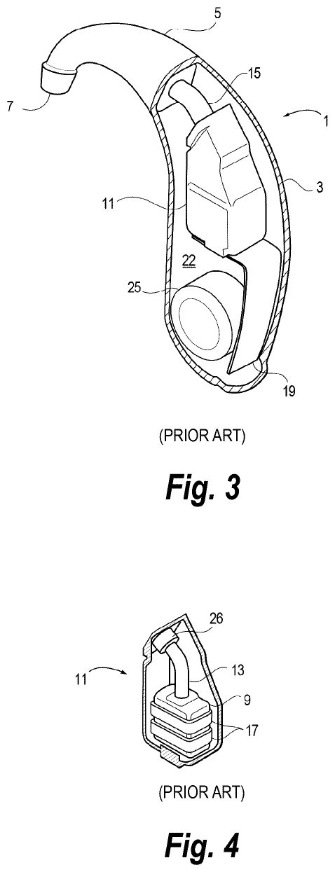

FIG. 2 and FIG. 3 show first and second perspective cross-sectional views of a prior art BTE hearing device 1. The prior art BTE hearing device 1 comprises a housing 3 defining an interior volume 22 in which various transducers and electronic components may be arranged and protected. The prior art BTE hearing device 1 comprises an acoustically sealed receiver chamber 11 arranged in the interior volume 22 of the housing 3. A loudspeaker 9, such as a receiver such as a balanced armature receiver, is suspended in a soft resilient suspension 17, that may be made of an elastomeric material, is arranged inside the sealed receiver chamber 11. Output sound generated by the receiver 9 travels through a receiver sound tubing 13 that is coupled to a sound port (not shown) of the receiver 9. The receiver sound tubing 13 may further be surrounded by a receiver tubing chamber 15 and further transmit the output sound through a hollow so-called hook 5 having a distal end with a sound outlet 7 where the output sound is emitted. The prior art hearing device 1 comprises an energy source like a battery 25 mounted in a mating battery chamber 23. The energy source may energize the previously discussed processing unit and other electronic components that may be mounted on a suitable carrier substrate to form an electronics assembly 19. The prior art BTE hearing device 1 further comprises a microphone arrangement (not shown) generally operating as discussed in connection with FIG. 1 and receiving sound through a microphone sound inlet 21.

The soft resilient suspension 17 of the receiver 9 may fully enclose the receiver casing on all sides or comprise a pair of elastomeric bands or belts wrapped around the casing of the receiver 9 as illustrated in FIG. 2. The soft resilient suspension 17 is thus arranged in-between the casing of the receiver 9 and an inner wall of the sealed receiver chamber 11 to isolate mechanical vibrations originating from the receiver 9 from the sealed receiver chamber 11. Thereby further isolate the mechanical vibrations from the housing 3. The skilled person will understand that the soft resilient suspension 17 occupies significant space around the receiver 9 which leads to a relatively large internal volume of the sealed receiver chamber 11 and a corresponding increase of dimensions of the receiver chamber 11. The increased dimensions of the receiver chamber 11 leads in turn to larger dimensions of the housing 3 of the hearing device 1 to accommodate the receiver chamber 11.

FIG. 4 is a cross-sectional perspective view of the sealed receiver chamber 11 mounted in the interior volume 22 of the housing 3 of the prior art BTE hearing device 1 shown in FIG. 3. The receiver 9 is mounted in the band-shaped, soft, resilient suspension 17. The receiver sound tube 13 is coupled to the sound port (not shown) of the receiver 9 and may be terminated with an acoustic/mechanical connector 26 at a distal end of the receiver sound tube 13.

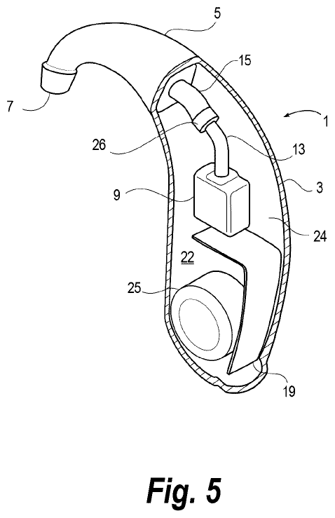

FIG. 5 is a cross-sectional perspective view of an exemplary BTE hearing device 1 according to some embodiments. Like elements and features of the exemplary BTE hearing device 1 are given the same reference numerals as the corresponding elements and features of the prior art BTE hearing devices disclosed above in connection with FIGS. 2-4. The inner wall 24 of the housing 3 defines the interior housing volume 22. A section or area of the inner wall 24 functions as a receiver support structure for the receiver 9. The receiver 9 may be rigidly fixed to the section or area of the inner wall 24 for example by an adhesive agent such as a non-compliant and healed glue or hardened glue.

In other embodiments, the receiver support structure comprises a recess (not shown) integrally formed on, or with, the housing 3, for example using injection molding-based manufacturing of the housing 3. The recess may be shaped and sized to mate to the casing of the receiver 9 in such manner that at least a part of the receiver casing is effectively press-fitted into the recess.

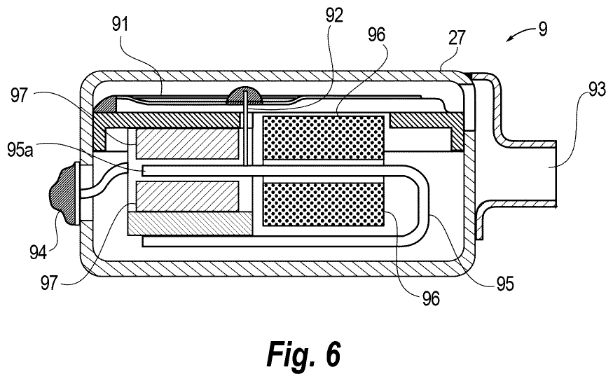

FIG. 6 is a vertical cross-sectional view of an exemplary balanced-armature receiver 9 that may be used as a loudspeaker for the output sound in various exemplary embodiments of the BTE hearing device 1 in accordance with the present disclosure. The receiver 9 comprises a vibratory motor assembly comprising a moving-armature type drive. The receiver 9 comprises a receiver casing 27 and a sound port 93. The receiver casing 27 may have a substantially box-like shape with two pairs of substantially plane and opposing walls to define the interior of the receiver 9. The receiver casing may be substantially closed, except for the sound port 93. The receiver casing may comprise, or be made of, a metallic material to provide high mechanical strength and good EMI shielding.

A moving armature drive of the exemplary balanced-armature receiver 9 comprises a pair of opposing permanent magnets 97 that includes respective plane inner surfaces defining an air gap there between. The vibratory motor assembly further comprises a U-shaped armature 95 which has leg portion 95a that extends into the air gap. A drive coil 96 is wound around the leg portion 95a. The receiver comprises a pair of input terminals or solder pads 94 that are connectable to the output terminals of a suitable power amplifier or signal processor of the hearing device such that the power amplifier applies signal voltage and current to the drive coil 96. The signal current flowing through the drive coil 96 induces a corresponding vibratory motion of the leg portion 95a of the armature 95. The leg portion 95a is mechanically connected to a compliant diaphragm 91 via a drive rod 92. Hence, the vibratory motion of leg portion 95a results in a corresponding vibratory motion of the compliant diaphragm 91 that therefore generate sound pressure corresponding to the signal voltage and current. The sound pressure generated by the vibratory motion of the compliant diaphragm 91 is finally emitted to the surroundings via the sound port 93.

The skilled person will appreciate that various alternative types of loudspeakers may be used in the exemplary embodiments of the BTE hearing device 1 in accordance with the present disclosure. The loudspeaker may comprise an electrodynamic drive, e.g., a moving coil type of loudspeaker or a piezo-electric drive configured to vibrate a diaphragm to generate and emit sound output.

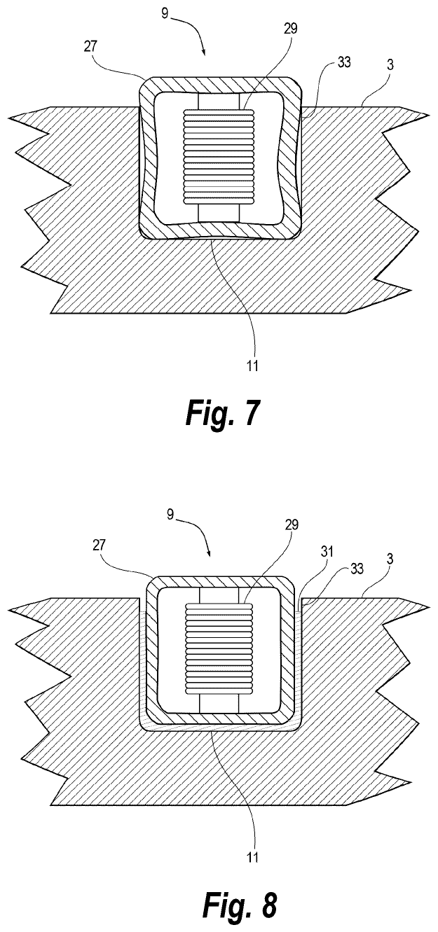

FIG. 7 is a schematic illustration of a press-fitted mounting of the exemplary receiver 9 in a receiver support structure 3 of the exemplary BTE hearing device 1 in accordance with a first embodiment. The receiver support structure 3 may comprise a receiver chamber 11 generally similar to the previously discussed sealed receiver chamber 11.

In this embodiment, the receiver chamber 11 has slightly smaller dimensions than those of the receiver casing 27. When the receiver 9 is press-fitted into the receiver chamber 11 of the receiver support structure 3, the walls of the receiver casing 27 are deformed slightly in a concave fashion by receiver chamber wall sections 33 of the receiver chamber 11. This deformation of the walls of the receiver casing 27 make corners of the receiver casing held firmly against the receiver chamber walls 33 by friction. The deformation of the walls of the receiver casing 27 due to the press-fitting is exaggerated in FIG. 7 for clarity. This deformation of the receiver casing 27 may be carried out by a suitable choice of hardness of the material and shape of the housing 3, or alternatively, the material of the receiver chamber 11. In that context, the inventor's experimental and finite-element simulation results on prototype BTE devices indicate that the material of the receiver support structure such as the receiver chamber or housing preferably possess a Young's modulus between 60 MPa and 200 MPa such as between 100 MPa and 140 MPa. The material of the receiver chamber 11 may comprise a polyether block amide of sufficient hardness, such as Pebax 5533.

The skilled person will understand that the receiver 9 is not surrounded by, or suspended in, any soft resilient suspension like the prior art hearing devices. At least one portion of the receiver casing 27 is instead rigidly fixed to the mating wall sections of the housing 3. In some embodiments all sides of the receiver casing 27 are instead rigidly fixed or attached to the mating wall sections 33 in the housing 3. Accordingly, the internal volume of the prior art hearing device housings occupied by the soft resilient suspension of the receiver is eliminated. The skilled person will appreciate that a corresponding reduction of the internal volume of the receiver chamber 11 is likewise obtained by the elimination of the soft resilient suspension around the receiver. In some cases, the volume required for the receiver may be reduced by more than 70% when the receiver is mounted according to some embodiments.

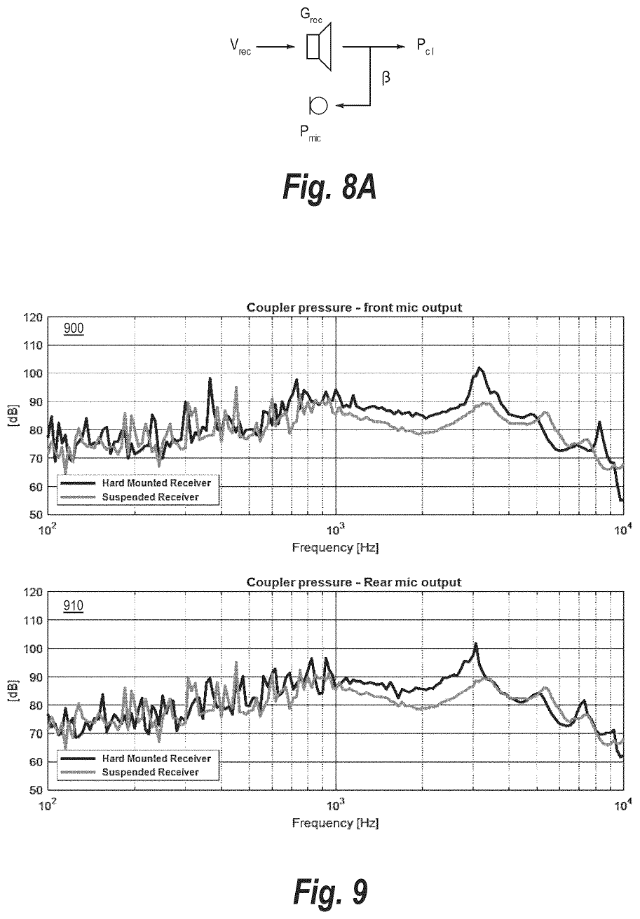

FIG. 8 is a schematic illustration of a mounting of the exemplary balanced-armature receiver 9 in a receiver support structure of the housing 3 of the exemplary BTE hearing device using a rigid, adhesive agent 31 in accordance with a second embodiment. In the present embodiment, the dimensions of the previously discussed receiver chamber wall sections 33 are slightly larger than the mating dimensions of the receiver casing 27, and the receiver casing 27 is thus not deformed during mounting in the receiver chamber 11. The receiver casing 27 is rigidly fixed to the receiver chamber wall sections 33 by an adhesive agent 31 such as a cured, hardened glue. The adhesive agent 31 may be disposed between at least one section of the receiver casing 27, such as a pair of plane opposing casing walls, and the mating receiver chamber wall sections 33. The adhesive agent 31 may, for instance, comprise a rapid-curing cyanoacrylate glue, an epoxy resin glue, a thermoplastic polymer glue such as a polyamide glue, a thermosetting polymer glue such as a polyester resin, or any other suitable, hardening adhesive. The glue is preferably applied prior to mounting the receiver 9 in the receiver chamber 11. Dependent on the type of glue, the glue may be applied to the receiver casing 27, the receiver chamber 11 or both. In this embodiment, the receiver chamber 11 has slightly larger dimensions than those of the receiver casing 27. Thus filling the resulting gap with the glue. Once the glue is hardened or cured, the receiver 9 remains rigidly fixated to the housing 3.

FIG. 9 shows experimentally measured maximum stable gains (G_{s,max}) of a prior art BTE hearing device in comparison to a prototype BTE hearing device in accordance with the present disclosure. The scale on the y-axis is arbitrary but accurately shows relative gains and the gain difference in dB. The BTE hearing devices are largely identical inter alia using identical microphones and receivers etc.

The graphs 900 and 910 show the measured maximum stable gains (G_{s,max}) of the prototype BTE hearing device with a hard-mounted receiver in accordance with some embodiments by a full line and a prior art BTE hearing device with a resiliently suspended receiver by a dotted line. Graph 900 shows G_{s,max} to a front microphone and graph 910 shows G_{s,max} to a rear microphone of the BTE hearing devices. As illustrated the prototype BTE hearing device has superior performance with marked increase of G_{s,max} in the important frequency range between 1 kHz and 5 kHz. The overall shape of both response curves shows a series of response peaks and valleys. These response peaks and valleys are the result of typical frequency responses of receivers for hearing devices, e.g. of the type 33AP015 from the supplier Sonion, or type CI-22955-000 from the supplier Knowles Electronics. The datasheets of these receivers are hereby incorporated by reference. At e.g., 3100 Hz, G_{s,max} of the BTE hearing device with a hard-mounted receiver may be increased by 10-12 dB and 8-10 dB with respect to the front microphone and rear microphone, respectively, compared to the BTE hearing device with the resiliently suspended receiver. The graphs 900, 910 also show that a typical 5 dB to 10 dB increase of G_{s,max} in the range between 1 kHz and 5 kHz from both the front microphone and the rear microphone by the hearing device with a hard-mounted receiver in accordance with some embodiments.

The surprising and favorable improvement of the G_{s,max} of the prototype BTE using rigid and fixed attachment of the receiver, i.e., a hard-mounted receiver, to the receiver support structure is caused by the fact that the acoustic feedback path discussed above is dominant over the mechanical feedback path in the useable frequency range of the hearing device. The hard-mount of the receiver effectively adds mass from the receiver support structure to the receiver and that mass absorbs vibrations of the receiver casing which in turn reduces the transfer through the mechanical feedback path to the microphone(s). Furthermore, a dominant resonant frequency (not shown in graphs 900, 910) is moved above 10 kHz by the hard-mounted receiver design. Thus, the dominant resonant frequency is moved above the frequency range of interest to the hearing device.

The measurement set-up for measuring the G_{s,max} of the prototype BTE comprises coupling its sound port to a standard acoustic coupler. A schematic circuit diagram of the variables of the measurement set-up is illustrated on FIG. 8A. The variables used are:
Receiver input/drive voltage: V_{rec}
Microphone output voltage: V_{mic}
Acoustic coupler pressure: P_{cl}
Sound pressure at microphone: P_{mic}
Microphone sensitivity: η_{aco} where _{aco} represents the microphone acoustic sensitivity.
The receiver transfer function: G_{rec}

Equivalent sound level at microphone converted from microphone voltage output:

$${P}_{mic} = \frac{{V}_{m i c}}{{η}_{a c o}}$$

P_{cl} and P_{mic} can be measured directly in the standard coupler.

$$\{ \begin{matrix}{P}_{cl} = {V}_{rec} \cdot {G}_{rec} \\ {P}_{mic} = {V}_{rec} \cdot {G}_{rec} \cdot β\end{matrix} ⇒ \frac{1}{β} = \frac{{P}_{cl}}{{P}_{mic}}$$

Finally, the resulting, maximum stable gain G_{s,max}, is calculated as:

$${G}_{s , max} = {P}_{cl} - {P}_{m i c}$$

The calculated values are then plotted to the graphs 900, 910 in dB. In this way, the maximum stable gain, G_{s,max}, over a range of frequencies may be obtained from the described measurement setup.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

1. A hearing device comprising:
a housing comprising an outer wall configured for arrangement at, or in, an ear of a user, the housing also comprising an inner wall defining an interior housing volume, wherein the housing comprises a receiver support structure, the receiver support structure comprising at least a part of an inner wall and/or a component extending from the inner wall of the housing; and
a receiver comprising a receiver casing, and a vibratory motor assembly inside the receiver casing;
wherein the receiver casing is fixed to the receiver support structure.

2. The hearing device according to claim 1, wherein at least one section of the receiver casing is press-fitted into a mating recess of the receiver support structure.

3. The hearing device according to claim 2, wherein a dimension of the at least one section of the receiver casing is larger than a dimension of the mating recess of the receiver support structure.

4. The hearing device according to claim 1, wherein at least one section of the receiver casing is attached to the receiver support structure by an adhesive agent.

5. The hearing device according to claim 1, wherein the receiver support structure comprises a receiver compartment configured to surround the receiver, wherein one or more walls of the receiver casing are fixed to one or more mating inner walls of the receiver compartment.

6. The hearing device according to claim 5, wherein the receiver compartment is closed to acoustically seal the receiver.

7. The hearing device according to claim 1, wherein the vibratory motor assembly of the receiver comprises a moving armature drive, an electrodynamic drive, or a piezo-electric drive;
wherein the moving armature drive, the electrodynamic drive, or the piezo-electric drive is configured to vibrate a diaphragm to generate sound.

8. The hearing device according to claim 1, wherein a material of the receiver support structure has a Young's modulus between 60 MPa and 200 MPa.

9. The hearing device according to claim 1, wherein a material of the receiver support structure has a Young's modulus between 120 MPa and 140 MPa.

10. The hearing device according to claim 1, wherein the receiver casing has a box-like shape.

11. The hearing device according to claim 1, wherein the receiver casing comprises two pairs of parallel wall sections.

12. The hearing device according to claim 1, wherein the receiver casing comprises a cylindrical shape.

13. The hearing device according to claim 1, wherein the hearing device is a BTE hearing device, an ITC hearing device, an ITE hearing device, or a RIC hearing device.

14. The hearing device according to claim 1, wherein the housing is manufactured by low-pressure molding around the receiver.

15. The hearing device according to claim 1, further comprising a microphone arrangement in the interior housing volume, wherein the microphone arrangement is configured to pick-up sound from a surrounding environment of the hearing device.

16. The hearing device according to claim 1, wherein a dominant resonance frequency of the receiver and housing assembly is above 10 kHz.
